(19) United States
(12) Patent Application Publication
(10) Pub. No.: US 2024/0226779 A9
(43) Pub. Date: Jul. 11, 2024

(54) MULTIPORT FILTER HOUSING AND FILTER THEREOF

(71) Applicant: ENTEGRIS, INC., Billerica, MA (US)

(72) Inventors: Matthew Schnaare, Shakopee, MN (US); Eric Grinde, St. Louis Park, MN (US); Ashutosh Shrikant Bhabhe, Karnataka (IN); Siddarth Sampath, Tyngsboro, MA (US)

(21) Appl. No.: 18/383,445

(22) Filed: Oct. 24, 2023

Related U.S. Application Data
(60) Provisional application No. 63/418,911, filed on Oct. 24, 2022.

(51) Int. Cl. B01D 29/15; B01D 29/23

(52) U.S. Cl. CPC B01D 29/15; B01D 29/23; B01D 61/145; B01D 2201/291

(57) ABSTRACT

A filter housing includes a sleeve, a first endcap coupled to a first open end of the sleeve, and a second endcap coupled to the second open end of the sleeve. The sleeve includes an interior volume with an outer radial portion and an inner radial portion. The first endcap includes first plurality of ports that connect to the outer radial portion and the inner radial portion of the interior volume of the sleeve. The second endcap includes a second plurality of ports that connect to the outer radial portion and the inner radial portion of the interior volume of the sleeve. The filter housing is configured to enclose a filter member in the sleeve between the first endcap and the second endcap. A method is for filtering liquid with a filter that includes a filter member and a filter housing.

### FIELD

This disclosure generally relates to a filter for filtering liquids. More specifically, this disclosure generally relates to a filter housing used in a filter for filtering liquid.

### BACKGROUND

Filters are employed to filter different liquids. For example, filters are employed in semiconductor manufacturing to remove contaminants from a fluid. A fluid (e.g., liquid, water, or the like) is directed through a filter. The filter removes contaminants from the fluid as it flows through the filter.

### SUMMARY

In an embodiment, a filter housing includes a sleeve, a first endcap, and a second endcap. The sleeve includes a first open end, a second open end, and an interior volume. The interior volume has an outer radial portion and an inner radial portion. The first endcap is removably coupled to the first open end of the sleeve. The first endcap includes a first plurality of ports that connect to the outer radial portion and the inner radial portion of the interior volume of the sleeve. The second endcap is coupled to the second open end of the sleeve. The second endcap includes a second plurality of ports that connect to the outer radial portion and the inner radial portion of the interior volume of the sleeve. At least one of the first endcap and the second endcap is removably coupled to the sleeve. The filter housing is configured to enclose a filter member in the sleeve between the first endcap and the second endcap.

A method is directed to filtering liquid with a filter that includes a filter member and a filter housing. The filter housing including a sleeve, a first endcap removably coupled to a first open end of the sleeve, and a second endcap coupled to a second open end of the sleeve. At least one of the first endcap and the second endcap is removably coupled to the sleeve. The first endcap includes a first plurality of ports. The second endcap includes a second plurality of ports. The filter member is disposed in the sleeve between the first endcap and the second endcap. The method includes supplying a liquid into the filter housing through at least a first port in the first plurality of ports in the first endcap. The method further includes directing a first portion of the liquid from the first port in the first endcap to a first port in the second plurality of ports, which includes passing the first portion of the liquid through the filter member. The method further includes discharging the first portion of the liquid from the filter through the first port in the second endcap, the first portion of the liquid being a permeate.

In an embodiment, a filter includes a filter member and a filter housing enclosing the filter member. The filter housing includes a sleeve, a first endcap, and a second endcap. The sleeve includes a first open end, a second open end, and an interior volume. The interior volume has an outer radial portion and an inner radial portion. The first endcap is removably coupled to the first open end of the sleeve. The first endcap includes first plurality of ports that connect to the outer radial portion and the inner radial portion of the interior volume of the sleeve. The second endcap is coupled to the second open end of the sleeve. The second endcap includes a second plurality of ports that connect to the outer radial portion and the inner radial portion of the interior volume of the sleeve. At least one of the first endcap and the second endcap is removably coupled to the sleeve. The filter housing is configured to enclose the filter member in the sleeve between the first endcap and the second endcap.

### DRAWINGS

FIG. 1 is a front perspective view of an exemplary embodiment of a filter.

FIG. 2 is an exploded view of the filter in FIG. 1, according to an embodiment.

FIG. 3 is a top view of the filter in FIG. 1, according to an embodiment.

FIG. 4 is a longitudinal cross sectional view of the filter as indicated in FIG. 3, according to an embodiment.

FIG. 5 is a longitudinal cross sectional view of the filter as indicated in FIG. 3, according to an embodiment.

FIG. 6A shows the longitudinal cross sectional view of the filter in FIG. 4 employing a first port configuration, according to an embodiment.

FIG. 6B shows the longitudinal cross sectional view of the filter in FIG. 4 employing a first port configuration, according to an embodiment.

Like numbers represent like features.

### DETAILED DESCRIPTION

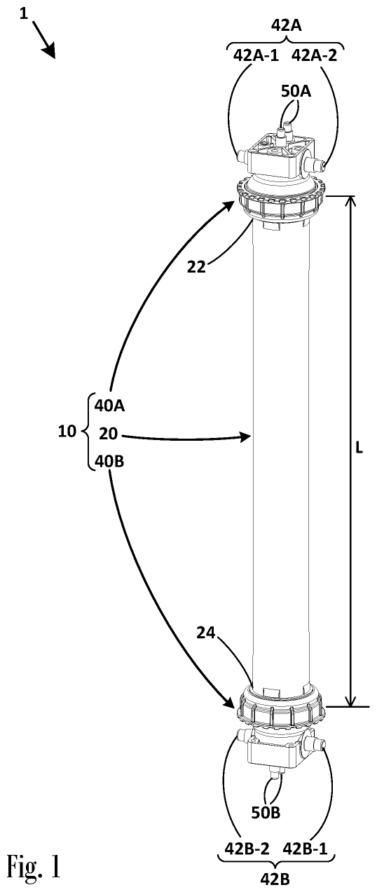

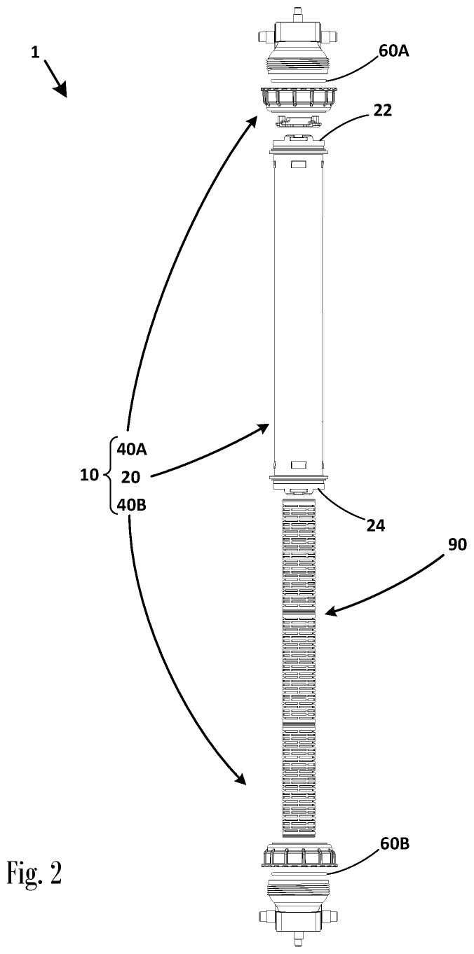

FIG. 1 is a front perspective view of a filter 1, according to an embodiment. FIG. 2 is an exploded view of the filter 1, according to an embodiment. The filter 1 includes a filter housing and a filter member 90. The filter housing 10 encloses the filter member 90. The filter member 90 is configured to be removable in the filter 1. For example, the filter member 90 is configured to be removable from the housing 10. The filter member 90 is shown outside of the filter housing in FIG. 2 for illustrated purposes of showing an exploded view. When assembled (as shown in FIG. 1), the filter member 90 is disposed within the filter housing 10.

The filter 1 is configured to filter a liquid. As liquid flows through the filter 1, at least a portion of the liquid passes through the filter member 90. The filter member 90 removes contaminants from the liquid as it passes through the filter member 90. The filtered liquid is then discharge from the filter 1. For example, the filtered liquid discharged from the filter 1 is the permeate. In an embodiment, the liquid is used to filter liquid used in semiconductor manufacturing. For example, the liquid may be a liquid used in lithography and/or a liquid used in wet etching and cleaning processes. For example, the liquid may be water (e.g., deionized water), acid(s), solvents, acids and/or bases used in wet etching and cleaning processes, solvents used in photolithography processes, and the like. The filter and filter housing disclosed herein can also be used in a variety of other applications, including, but not limited to, filtering for diagnostic applications, inkjet applications, filtering fluids for the pharmaceutical industry, filtering fluids for medical applications, filtering biological fluids, filtering fluids for food and beverage industry, clarifications, or filtering cell culture fluids. In an embodiment, the filter 1 is a filter system configured to provide ultrafiltration of water.

As shown in FIG. 1, the housing 10 includes a sleeve 20, a first endcap 40A, and a second endcap 40B. The sleeve 20 includes a first open end 22 and a second open end 24. In the illustrated embodiment, each of endcaps 40A, 40B is removably coupled to the sleeve 20. The first endcap 40A and the second endcap 40B are removably coupled to the opposite ends 22, 24 of the sleeve 20. For example, the first endcap 40A is removably coupled to the first open end 22 of the sleeve 20, and the second endcap 40B is removably coupled to the second open end 24 of the sleeve 20. Each endcap 40A, 40B can include a seal 60A, 60B that provides sealing between the respective endcap 40A, 40B and the sleeve 20.

At least one of the endcaps 40A, 40B is removably coupled to the sleeve 20. In another embodiment, one of the endcaps 40A, 40B may be fixedly coupled (e.g., thermally fused, formed as part of the sleeve 20, or the like) to the sleeve 20. For example, the first endcap 40A is fixedly coupled to the sleeve 20 and the second endcap 40A is removably coupled to the sleeve 20. Each endcap 20 may be made of a material that includes, for example (but not limited to), one or more of polypropylene, perfluoroalkoxy alkane (PFAs), and the like.

As shown in FIG. 2, the sleeve 20 has a tubular shape. The sleeve 20 can be made of a material that are generally unreactive to the liquid being filtered and be used in extrusion molding. Materials for the sleeve 20 may include, for example (but not limited to), one or more of polypropylene, perfluoroalkoxy alkane (PFAs), and the like. As shown in FIGS. 1 and 2, the sleeve 20 may be made of single part. The sleeve 20 may be formed from by bonding multiple parts together (e.g., thermal bonding, and the like). For example, the sleeve 20 in an embodiment may be formed by bonding end portions (end portions that each include one of the open ends 22 configured to be coupled to a respective one of the endcaps 40A, 40B) to a middle portion.

The sleeve 20 has an axial length L. The axial length L extends from the first open end 22 to the second open 24 of the sleeve 20. In some embodiments, the axial length L of the sleeve 20 is less than 40 inches. In an embodiment, the axial length L of the sleeve 20 is greater than 5 inches. In an embodiment, the axial length L of the sleeve 20 is at least 10 inches.

The housing 10 includes a first plurality of ports 42A disposed in the first endcap 40A and a second plurality of ports 42B disposed in the second endcap 40B. The liquid to be filtered is supplied into the filter 1 through one or more of the ports in the first and second pluralities of ports 42A, 42B. The filtered liquid (i.e., the liquid after being passing through the filter member 90) is discharged from the filter 10 through one or more of the ports in the first and second pluralities of ports 42A, 42B. The flow into, through, and out of the filter 1 is discussed in more detail below.

The first endcap 40A includes the first plurality of ports 42A. The first plurality of ports 42A each extend through the first endcap 40A. The second endcap 40B includes the second plurality of ports 42B. The second plurality of ports 42B each extend through the second endcap 40B. The first endcap 40A and/or the second endcap 40B may also include one or more auxiliary ports 50A, 50B. The auxiliary ports 50A, 50B are discussed in more detail below.

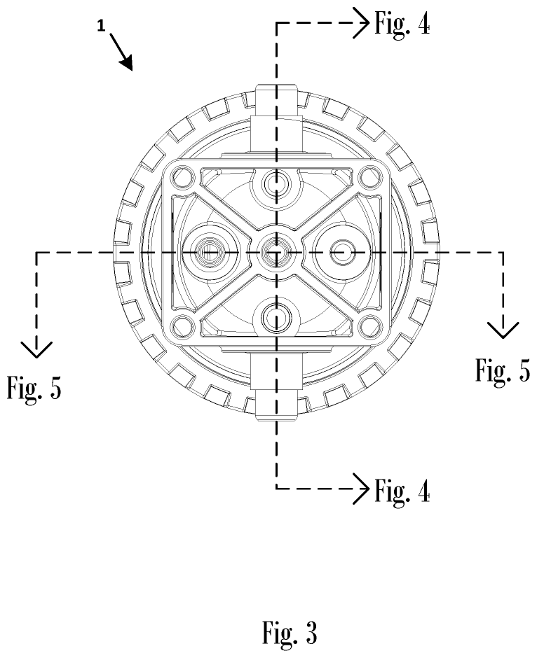

FIG. 3 is a top view of the filter 1, according to an embodiment. For example, FIG. 3 is a top view of the first endcap 40A of the filter 1.

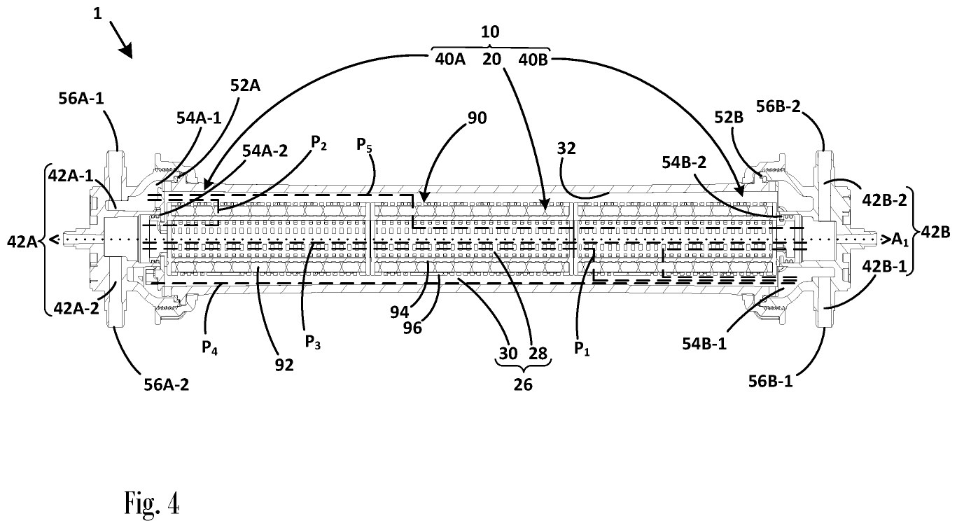

FIG. 4 is a longitudinal cross sectional view of the filter 1 as shown in FIG. 3, according to an embodiment. As shown in FIG. 4, the sleeve 20 includes an interior volume 26. The interior volume 26 includes an inner radial portion 28 and an outer radial portion 30. The inner radial portion 28 may be disposed along the longitudinal axis Ai of the sleeve 20. The outer radial portion encircles the inner radial portion 28. For example, the outer radial portion 30 has a tubular shape, and the inner radial portion 28 is disposed within the tubular shape of the outer radial portion 30. The outer radial portion 30 and the sleeve 20 are coaxial. For example, the outer radial portion and the sleeve 20 have the same longitudinal axis Ai.

The outer radial portion 30 is located closer to the inner surface 32 of the sleeve 20 than the inner radial portion 28. The filter member 90 is disposed in the interior volume 26 between the inner radial portion 28 and the outer radial portion 30 of the interior volume 26. For example, the filter member 90 may be separate the inner radial portion 28 from the outer radial portion 30 of the interior volume.

The filter member 90 is disposed in the sleeve 20 between the first endcap 40A and the second endcap 40B. The filter member 90 contacts both the first endcap 40A and the second endcap 40B. The filter member 90 is configured to operate by the liquid flowing through the material of the sidewall 92 of the filter member 90. The contaminants in the liquid are trapped in the material of the sidewall 92 while the liquid passes through the sidewall 92.

The sidewall 92 of the filter member 90 is made of a porous material configured to allow the liquid to pass therethrough while preventing contaminants in the liquid from passing therethrough. Contaminants can include solid contaminants and/or dissolved contaminants in the liquid. For example, the contaminants are trapped in the filter member 90 and/or remain in a retentate stream of the liquid. In an embodiment, the porous material of the filter member 90 may be made out of, for example (but not limited to), one or more of polytetrafluoroethylene (PTFE), polypropylene, polyethylene (e.g., high-density polyethylene (HDPE), ultra-high-molecular-weight polyethylene (UHMWPE), and the like), polysulfone, and the like. The sidewall 92 of the filter member 90 may be in the form of a pleated porous material. In an embodiment, the filter 1 is an ultrafiltration filter and the filter member 90 is configured to provide ultrafiltration of the liquid. As noted above, ultrafiltration of water is an exemplary application for the filter and filter housing disclosed herein and can be used for a variety of filtering applications.

As shown in FIG. 4, the porous sidewall 92 of the filter member 90 may be supported by a rigid core 94 and/or a rigid outer wall 96. For example, the porous sidewall 92 may be wrapped around the rigid core 94, and supported between the rigid core 94 and rigid outer wall 96. Each of the rigid core 94 and the rigid outer wall 96 has openings to allow for the liquid to freely flow therethrough.

The filter member 90 is disposed in the interior volume 26 of the sleeve 20. The inner radial portion 28 of the interior volume 26 of the sleeve 20 is disposed within the filter member 90. For example, the inner radial portion 28 is disposed within the filter member 90 (e.g., the filter member encircling the inner radial portion 28). The outer radial portion 30 is disposed between the filter member 90 and the sleeve 20 (e.g., the outer radial portion 30 sandwiched between the outer surface of the filter member 90 and the inner surface 32 of the sleeve 20.

The first endcap 40A has an end 52A that faces the first open end 22 of the sleeve 20. The end 52A of the first endcap 40A is removably coupled to the sleeve 20. For example, in the illustrated embodiment, the first endcap 40A is removably coupled to the sleeve 20 by the first endcap 40A and the sleeve 20 being screwed together. It should be appreciated that the first endcap 40A in another embodiment may be removably coupled to the sleeve in a different manner then by being screwed together.

As discussed above, the first endcap 40A and the second endcap 40B may be removably coupled to the sleeve 20. The removability of the first endcap 40A and the second endcap 40B allows for removal and replacement of the filter member 90 from the housing 10. For example, once the filter member has operated for a set period, operation time, etc., at least one of the endcaps 40A, 40B is the filter member is removed from the housing and replaced with a new filter member. The first endcap 40A and/or the second endcap 40B is removed/uncoupled from the sleeve 20 to allow for accessing, removal, and replacement of the filter member 90.

The first plurality of ports 42A in the first endcap 40A and the second plurality of ports 42B in the second endcap 40B connect to the interior volume 26. The first plurality of ports 42A in the first endcap 40A includes an outer radial port 42A-1 and an inner radial port 42A-2. The second plurality of ports 42B in the second endcap 40B includes an outer radial port 42B-1 and an inner radial port 42B-2. In each endcap 40A, 40B, the outer radial port 42A-1, 42B-1 connects to the interior volume 26 at a location that is closer to the sleeve 20 than the inner radial port 42A-2, 42B-2.

The outer radial ports 42A-1, 42B-1 and the inner radial ports 42A-2, 42B-2 are configured for supplying the fluid (i.e., the fluid to be filtered) into the housing 10 and/or discharging the filtered fluid (i.e., the fluid after being filtered by the filter member 90) from the housing 10. For example, each of the outer radial ports 42A-1, 42B-1 is for transferring fluid into and/or from the interior volume 26 of the sleeve 20 exterior to filter member 90 (e.g., supplying to the outer radial portion 30, receiving from the outer radial portion 30). For example, each of the inner radial ports 42A-2, 42B-2 is for transferring fluid into and/or from inside the filter member 90 (e.g., supplying to the inner radial portion 28, receiving from the inner radial portion 28).

The outer radial port 42A-1 in the first endcap 40A connects to the outer radial portion 30 of the interior volume 26 of the sleeve 20. The outer radial port 42A-1 extends through the first endcap 40A to the outer radial portion 30 of the interior volume 26 of the sleeve 20. For example, the outer radial port 42A-1 includes a first opening 54A-1 disposed in the end 52A of the first endcap 40A that faces the interior volume 26 of the sleeve 20 and a second opening 56A-1 disposed in the exterior of the first endcap 40A (e.g., disposed in the exterior of the housing 10). The first opening 54A-1 is disposed within filter 1 and faces the outer radial portion 30 of the interior volume 26 of the sleeve 20. The first opening 54A-1 is configured to allow flow of liquid between the outer radial portion 30 and first endcap 40A (e.g., flow from the outer radial portion 30 into the first endcap 40A, flow from the first endcap 40A into the outer radial portion 30).

The inner radial port 42A-2 in the first endcap 40A connects to the inner radial portion 28 of the interior volume 26 of the sleeve 20. The inner radial port 42A-2 extends through the first endcap 40A to the inner radial portion 28 of the interior volume 26 of the sleeve 20. For example, the inner radial port 42A-2 includes a first opening 54A-2 disposed in the end 52A of the first endcap 40A that faces the interior volume 26 of the sleeve 20 and a second opening 56A-2 disposed in the exterior of the first endcap 40A (e.g., located on the exterior of the housing 10). The first opening 54A-2 is disposed within the housing 10 and faces the inner radial portion 28 of the interior volume 26 of the sleeve 20. The first opening 54A-2 is configured to allow flow of liquid between the inner radial portion 28 and first endcap 40A (e.g., flow from the inner radial portion 28 into the first endcap 40A, flow from the first endcap 40A into the inner radial portion 28). As shown in FIG. 4, the first opening 54A-1 of the outer radial port 42A-1 is located closer to the sleeve 20 than the first opening 54A-2 of the outer radial port 42A-2.

The outer radial port 42B-1 in the second endcap 40B connects to the outer radial portion of the interior volume 26 of the sleeve 20. The outer radial port 42B-1 extends through the second endcap 40B to the outer radial portion 30 of the interior volume 26 of the sleeve 20. For example, the outer radial port 42B-1 includes a first opening 54B-1 disposed in the end 52B of the second endcap 40B that faces the interior volume 26 of the sleeve 20 and a second opening 56B-1 disposed in the exterior of the first endcap 40A (e.g., disposed in the exterior of the housing 10). The first opening 54B-1 is disposed inside the housing 10 and faces the outer radial portion 30 of the interior volume 26 of the sleeve 20. The first opening 54B-1 is configured to allow flow of liquid between the outer radial portion 30 and second endcap 40B (e.g., flow from the outer radial portion 30 into the second endcap 40B, flow from the second endcap 40B into the outer radial portion 30).

The inner radial port 42B-2 in the second endcap 40B connects to the inner radial portion 28 of the interior volume 26 of the sleeve 20. The inner radial port 42B-2 extends through the second endcap 40B to the inner radial portion 28 of the interior volume 26 of the sleeve 20. For example, the inner radial port 42B-2 includes a first opening 54B-2 disposed in the end 52B of the second endcap 40B that faces the interior volume 26 of the sleeve 20 and a second opening 56B-2 disposed in the exterior of the second endcap 40B (e.g., located on the exterior of the housing 10). The first opening 54B-2 is disposed inside the housing 10 and faces the inner radial portion 28 of the interior volume 26 of the sleeve 20. The first opening 54B-2 is configured to allow flow of liquid between the inner radial portion 28 and second endcap 40B (e.g., flow from the inner radial portion 28 into the second endcap 40B, flow from the second endcap 40B into the inner radial portion 28). As shown in FIG. 4, the first opening 54B-1 of the outer radial port 42B-1 is located closer to the sleeve 20 than the first opening 54B-2 of the outer radial port 42B-2.

As shown in FIG. 4, the filter 1 includes a first fluid pathway P₁, a second fluid pathway P₂, and a third fluid pathway P₃, a fourth fluid pathway P₄, and a fifth fluid pathway P₅. The fluid pathways are routes connecting the ports 42A, 42B through the interior volume 26. Fluid may not flow in some of the shown fluid pathways depending upon how the filter 1 is being employed. For example, which one or more of the ports 42A, 42B are being supplied with the fluid to be filtered (e.g., operating as inlet ports), which of the remaining ports 56A are left open (e.g., operating as outlet ports).

The first fluid pathway P₁ extends from the inner port 42A-2 in the first endcap 40A to the outer port 42B-1 in the second endcap 40B. The second fluid pathway P₂ extends from the inner port 42A-2 in the first endcap 40A to the outer port 42A-1 in the first endcap 40A. The fifth fluid pathway P₅ extends from the outer port 42A-1 in the first endcap 40A to the inner port 42B-2 in the second endcap 40B. Each of the first fluid pathway P₁, the second fluid pathway P₂, and the third fluid pathway P₃ extend through filter member 90 as the fluid pathway extends between its respective ports 42A, 42B. Fluid that the flows through/follows first fluid pathway P₁, the second fluid pathway P₂, or the third fluid pathway P₃ is filtered by the filer member 90 and can be discharged from the filter 1 as permeate.

The third fluid pathway P₃ extends from the inner port 42A-2 in the first endcap 40A to the inner port 42B-2 in the second endcap 40B without passing through the filter member 90. The fourth fluid pathway P₄ extends from the outer port 42A-1 in the first endcap 40A to the outer port 42B-1 in the second endcap 40B without passing through the filter member 90. Fluid that the flows through/follows the third fluid pathway P₃ or the fourth fluid pathway P₄ is not filtered by the filer member 90 and can be discharged from the filter 1 as retentate.

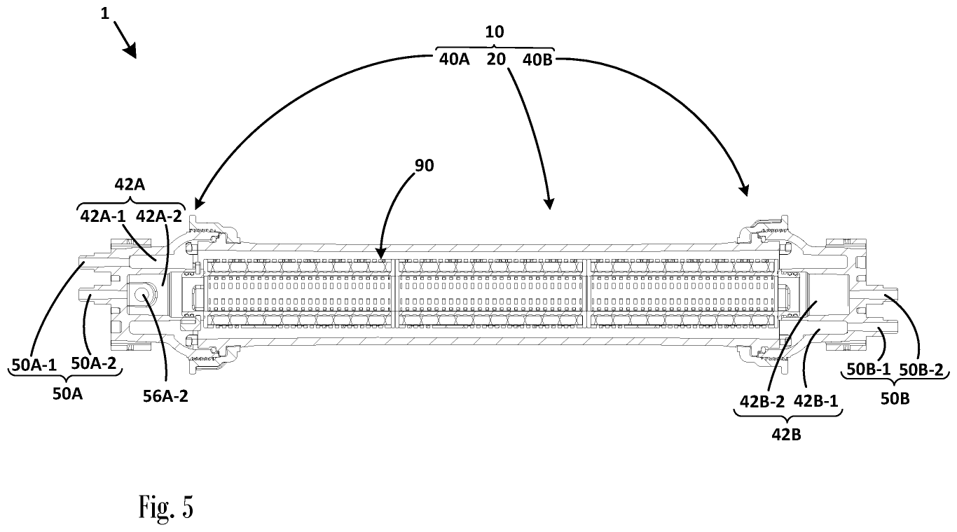

FIG. 5 is a cross sectional view of the filter 1 as shown in FIG. 3, according to an embodiment. FIG. 5 illustrates the connections between the auxiliary ports 50A and the first plurality of ports 42A in the first endcap 40A and the connections between the auxiliary ports 50B and the second plurality of ports 42B in the second endcap 50B.

The auxiliary ports 50A each connect to one of the first plurality of ports 42A within the first endcap 40A. Each auxiliary port 50A respectively extends to one of the first plurality of ports 42A. For example, the auxiliary ports 50A can include a first auxiliary port 50A-1 that connects to the outer port 42A-1 within the first endcap 40A and a second auxiliary port 50A-2 that connects to the inner port 42A-1 within the first endcap 40A.

The auxiliary ports 50B each connect to one of the second plurality of ports 42B within the second endcap 40B. Each auxiliary port 50B respectively extends to one of the second plurality of ports 42B. For example, the auxiliary ports 50B can include a first auxiliary port 50B-1 that connects to the outer port 42B-1 within the second endcap 40B and a second auxiliary port 50B-2 that connects to the inner port 42B-1 within the second endcap 40B.

In an embodiment, one or more of the auxiliary port(s) 50A, 50B is for discharging a portion of the filtered liquid from the filter 1. In an embodiment, one or more of the auxiliary port(s) 50A, 50B may be a drain and/or a vent for the filter 1. For example, a drain can be configured to be used for removing any remaining liquid from the filter housing 10 (e.g., prior to removing the filter 1, prior to opening/disassembling of the filter housing 10). For example, a vent can be configured to be used for removing gas from the filter housing 10 (e.g., removing trapped gas from within the housing 10).

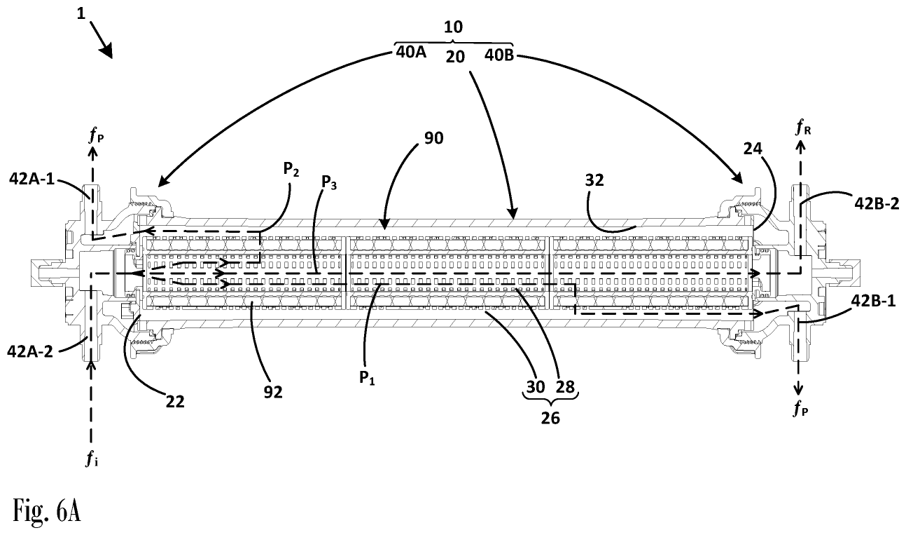

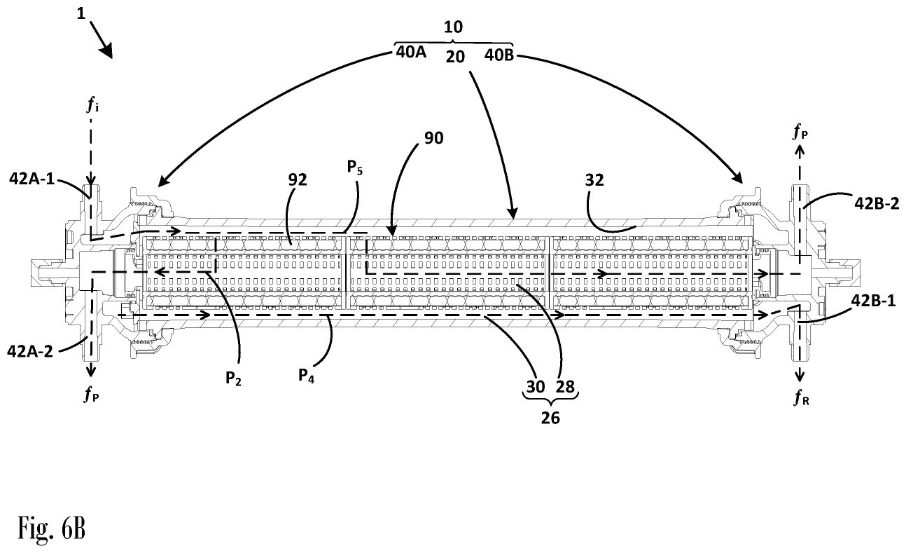

FIG. 6A is the cross sectional view of the filter 1 in FIG. 4 in a first port configuration, according to an embodiment. In the first port configuration, an inlet fluid fᵢ that is the fluid to be filtered is supplied to the inner port 42A-2 in the first endcap 40A. The outer port 42A-1 in the first endcap 40A, the outer port 42B-1 in the second endcap 40B, and the inner port 42B-2 in the second endcap 40B are open (e.g., not plugged, capped, or the like). The auxiliary ports 50A, 50B are capped.

A first portion of the inlet fluid fᵢ flows from the inner port 42A-2 in the first endcap 40A through the filter member 90 to the outer port 42B-1 in the second endcap 42B. For example, the first portion the inlet fluid fᵢ is flowing through the first flow pathway P₁. This filtered first portion of the inlet fluid fᵢ is then discharged from the second endcap 40B (e.g., from the outer port 42B-1) as permeate f_{P}. A second portion of the inlet fluid fᵢ flows from the inner port 42A-2 in the first endcap 40A through the filter member 90 to the outer port 42A-1 in the first endcap 40A. For example, this second portion of the inlet fluid fᵢ is flowing through the second flow pathway P₂. This filtered second portion of the inlet fluid fᵢ is then discharged from the first endcap 40A (e.g., from the outer port 42B-1) as permeate f_{P}. As discussed with respect to the fluid flow through the flow pathways, passing through the filter member 90 refers to passing through the porous sidewall 92 of the filter member 90.

A third portion of the inlet fluid fᵢ flows from the inner port 42A-2 in the first endcap 40A to the inner port 42B-2 in the second endcap 40B without passing through the filter member 90. This third portion of the inlet fluid fᵢ is not filtered as it does not pass through the filter member 90. For example, this third portion of the inlet fluid fᵢ is flowing through the fifth flow pathway P₅. This filtered portion of the inlet fluid fᵢ is then discharged from the second endcap 40B (e.g., from the outer port 42B-1) as retentate f_{R}.

As shown in FIG. 6A, the filter 1 in the first port configuration has one stream of inlet fluid fᵢ and produces two streams of permeate and one stream of retentate. It should be appreciated that in other port configurations, the inner port 42A-2 in the second endcap 42B-2, the outer port 42A-1 in the first endcap 42A, and/or the outer port 42B-1 in the second endcap 42B may be closed (e.g., capped, blocked, or the like). For example, the inner port 42B-2 in the second endcap 52B and one of the outer port 42A-1 in the first endcap 40A or the outer port 42B-1 in the second endcap 40B may be closed in other configurations. In some port configurations, a second stream of the inlet fluid fᵢ may be supplied to the inner port 42B-2 in the second endcap 40B. In some port configurations, the auxiliary ports 50A, 50B may also be opened and used for supplying additional stream(s) of the inlet fluid fᵢ into the filer 1, for discharging additional stream(s) of permeate f_{P} from the filter 1, and/or for discharging additional stream(s) of retentate f_{R} from the filter 1.

FIG. 6B is the cross sectional view of the filter 1 in FIG. 4 in a second port configuration, according to an embodiment. In the second port configuration, an inlet fluid fᵢ that is the fluid to be filtered is supplied to the outer port 42A-1 in the first endcap 40A. The inner port 42A-2 in the first endcap 40A, the outer port 42B-1 in the second endcap 40B, and the inner port 42B-2 in the second endcap 40B are open. The auxiliary ports 50A, 50B are capped.

A first portion of the inlet fluid fᵢ flows from the outer port 42A-1 in the first endcap 40A through the filter member 90 to the inner port 42A-2 in the first endcap 42A. For example, the first portion the inlet fluid fᵢ is flowing through the second flow pathway P₂. This filtered first portion of the inlet fluid fᵢ is then discharged from the first endcap 40A (e.g., from the inner port 42A-2) as permeate f_{P}. A second portion of the inlet fluid fᵢ flows from the outer port 42A-1 in the first endcap 40A through the filter member 90 to the inner port 42B-2 in the second endcap 40B. For example, the second portion the inlet fluid fᵢ is flowing through the fifth flow pathway P₅. This filtered second portion of the inlet fluid fᵢ is then discharged from the second endcap 40B (e.g., from the inner port 42B-2) as permeate f_{P}.

A third portion of the inlet fluid fᵢ flows from the outer port 42A-1 in the first endcap 40A to the outer port 42B-1 in the second endcap 40B without passing through the filter member 90. This third portion of the inlet fluid fᵢ is not filtered as does not pass through the filter member 90. For example, the third portion the inlet fluid fᵢ is flowing through the fourth flow pathway P₄. This filtered portion of the inlet fluid fᵢ is then discharged from the second endcap 40B (e.g., from the outer port 42B-1) as retentate f_{R}.

As shown in FIG. 6B, the filter 1 in the first port configuration has one stream of inlet fluid fᵢ and produces two streams of permeate and one stream of retentate. It should be appreciated that in other port configurations, the inner port 42A-2 in the first endcap, the inner port 42A-2 in the second endcap 42B-2, and/or the outer port 42B-1 in the second endcap 42B may be closed. For example, the outer port 42B-1 in the second endcap 52B and one of the inner port 42A-2 in the first endcap 40A or the outer port 42B-1 in the second endcap 40B may be closed in other port configurations. In some port configurations, a second stream of the inlet fluid fᵢ may be supplied to the outer port 42B-1 in the second endcap 40B. In some port configurations, the auxiliary ports 50A, 50B may also be opened and used for supplying additional stream(s) of the inlet fluid fᵢ into the filer 1, for discharging additional stream(s) of permeate f_{P} from the filter 1, and/or for discharging additional stream(s) of retentate f_{R} from the filter 1.

Aspects:

Any of Aspects 1-10 may be combined with any of Aspects 11-19, and any of Aspects 11-16 may be combined with any of Aspects 17-19.

Aspect 1. A filter housing, comprising: a sleeve including a first open end, a second open end, and an interior volume, the interior volume having an outer radial portion and an inner radial portion; a first endcap coupled to the first open end of the sleeve, the first endcap including a first plurality of ports that connect to the outer radial portion and the inner radial portion of the interior volume of the sleeve; and a second endcap coupled to the second open end of the sleeve, the second endcap including a second plurality of ports that connect to the outer radial portion and the inner radial portion of the interior volume of the sleeve, wherein at least one of the first endcap and the second endcap is removably coupled to the sleeve, and the filter housing is configured to enclose a filter member in the sleeve between the first endcap and the second endcap.

Aspect 2. The filter housing of Aspect 1, wherein the first plurality of ports includes an outer port that extends to the outer radial portion of the interior volume of the sleeve and an inner port that extends to the inner radial portion of the interior volume of the sleeve, and the second plurality of ports includes an outer port that extends to the outer radial portion of the interior volume of the sleeve and an inner port that extends to the inner radial portion of the interior volume of the sleeve.

Aspect 3. The filter housing of Aspect 2, wherein the first endcap including one or more auxiliary ports that respectively extend through the first endcap to one of the inner port and the outer port in the first endcap.

Aspect 4. The filter housing of any one of Aspects 1-3, further comprising: a first fluid pathway extending from a first port in the first plurality of ports to a first port in the second plurality of ports, the first fluid pathway configured to extend through the filter member, and a second fluid pathway extending from the first port in the first plurality of ports to a second port in the first plurality of ports, the first fluid pathway configured to extend through the filter member.

Aspect 5. The filter housing of Aspect 4, further comprising: a third fluid pathway that extends from the first port in the first plurality of ports to a second port in the second plurality of ports, the third fluid pathway configured to not pass through the filter member.

Aspect 6. The filter housing of any one of Aspects 1-5, wherein the first endcap includes an end that faces the first open end of the sleeve, each port in the first plurality of ports having a respective opening in the end of the first endcap, and the second endcap includes an end that faces the second open end of the sleeve, each port in the second plurality of ports having a respective opening in the end of the second endcap.

Aspect 7. The filter housing of any one of Aspects 1-6, wherein the sleeve has a tubular shape.

Aspect 8. The filter housing of any one of Aspects 1-7, wherein a longitudinal axis of the sleeve and a longitudinal axis of the filter member are coaxial.

Aspect 9. The filter housing of any one of Aspects 1-8, wherein sleeve has an axial length that extends from the first end of the sleeve to the second end of the sleeve, and the axial length of the sleeve being less than 40 inches.

Aspect 10. The filter housing of any one of Aspects 1-9, wherein the outer radial portion has a tubular shape that encircles the inner radial portion, and the filter housing is configured to dispose the filter member in the interior volume of the sleeve between the outer radial portion and the inner radial portion of the interior volume.

Aspect 11. A method of filtering liquid with a filter that includes a filter member and a filter housing, the filter housing including a sleeve, a first endcap coupled to a first open end of the sleeve and including a first plurality of ports, a second endcap coupled to a second open end of the sleeve and including a second plurality of ports, at least one of the first endcap and the second endcap being removably coupled to the sleeve, and the filter member disposed in the sleeve between the first endcap and the second endcap, the method comprising: supplying a liquid into the filter housing through at least a first port in the first plurality of ports in the first endcap; directing a first portion of the liquid from the first port in the first endcap to a first port in the second plurality of ports, which includes passing the first portion of the liquid through the filter member; and discharging the first portion of the liquid from the filter through the first port in the second endcap, the first portion of the liquid being a permeate.

Aspect 12. The method of Aspect 11, further comprising: directing a second portion of the liquid from the first port in the first endcap to a second port in the first plurality of ports, which includes passing the second portion of the liquid through the filter member, the second portion of the liquid being a permeate.

Aspect 13. The method of Aspect 11, further comprising: directing a second portion of the liquid from the first port in the first endcap to a second port in the first endcap without passing through the filter member, discharging the second portion of the liquid from the filter through the second port in the second endcap, the second portion of the liquid being a retentate.

Aspect 14. The method of any one of Aspects 11-13, wherein the first endcap includes an end that is removably coupled to the first open end of the sleeve, each port in the first plurality of ports having a respective opening in the end of the first endcap, the second endcap includes an end that is removably coupled to the second open end of the sleeve, each port in the second plurality of ports having a respective opening in the end of the second endcap, and the directing of the first portion of the liquid includes directing the first portion of the liquid from the respective opening of the first port in the first plurality of ports to the respective opening of the first port in second plurality of ports.

Aspect 15. The method of any one of Aspects 11-14, wherein the sleeve has an axial length that extends from the first end of the sleeve to the second end of the sleeve, and the axial length of the sleeve being less than 40 inches.

Aspect 16. The method of any one of Aspects 11-15, wherein the filter member has a tubular shape, an outer radial volume is formed between the sleeve and the filter member, the outer radial volume having a tubular shape that encircles the filter member.

Aspect 17. A filter, comprising: a filter member; and a filter housing enclosing the filter member, the filter housing including: a sleeve including a first open end, a second open end, and an interior volume, the filter member disposed in the interior volume of the sleeve, the interior volume having an outer radial portion and an inner radial portion; a first endcap coupled to the first open end of the sleeve, the first endcap including a first plurality of ports that connect to the outer radial portion and the inner radial portion of the interior volume of the sleeve; and a second endcap coupled to the second open end of the sleeve, the second endcap including a second plurality of ports that connect to the outer radial portion and the inner radial portion of the interior volume of the sleeve, wherein at least one of the first endcap and the second endcap is removably coupled to the sleeve, and the filter member is enclosed in the sleeve between the first endcap and the second endcap.

Aspect 18. The filter of Aspect 17, wherein the filter member is configured to filter liquid and to be replaceable from the housing.

Aspect 19. The method of any one of Aspects 17 and 18, wherein the sleeve has a tubular shape, and a longitudinal axis of the sleeve and a longitudinal axis of the filter member are coaxial.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

What is claimed is:

1. A filter housing, comprising:
a sleeve including a first open end, a second open end, and an interior volume, the interior volume having an outer radial portion and an inner radial portion;
a first endcap coupled to the first open end of the sleeve, the first endcap including a first plurality of ports that connect to the outer radial portion and the inner radial portion of the interior volume of the sleeve; and
a second endcap coupled to the second open end of the sleeve, the second endcap including a second plurality of ports that connect to the outer radial portion and the inner radial portion of the interior volume of the sleeve,
wherein at least one of the first endcap and the second endcap is removably coupled to the sleeve, and the filter housing is configured to enclose a filter member in the sleeve between the first endcap and the second endcap.

2. The filter housing of claim 1, wherein
the first plurality of ports includes an outer port that extends to the outer radial portion of the interior volume of the sleeve and an inner port that extends to the inner radial portion of the interior volume of the sleeve, and
the second plurality of ports includes an outer port that extends to the outer radial portion of the interior volume of the sleeve and an inner port that extends to the inner radial portion of the interior volume of the sleeve.

3. The filter housing of claim 2, wherein
the first endcap including one or more auxiliary ports that respectively extend through the first endcap to one of the inner port and the outer port in the first endcap.

4. The filter housing of claim 1, further comprising:
a first fluid pathway extending from a first port in the first plurality of ports to a first port in the second plurality of ports, the first fluid pathway configured to extend through the filter member, and
a second fluid pathway extending from the first port in the first plurality of ports to a second port in the first plurality of ports, the second fluid pathway configured to extend through the filter member.

5. The filter housing of claim 4, further comprising:
a third fluid pathway that extends from the first port in the first plurality of ports to a second port in the second plurality of ports, the third fluid pathway configured to not pass through the filter member.

6. The filter housing of claim 1, wherein
the first endcap includes an end that faces the first open end of the sleeve, each port in the first plurality of ports having a respective opening in the end of the first endcap, and
the second endcap includes an end that faces the second open end of the sleeve, each port in the second plurality of ports having a respective opening in the end of the second endcap.

7. The filter housing of claim 1, wherein the sleeve has a tubular shape.

8. The filter housing of claim 1, wherein a longitudinal axis of the sleeve and a longitudinal axis of the filter member are coaxial.

9. The filter housing of claim 1, wherein sleeve has an axial length that extends from the first end of the sleeve to the second end of the sleeve, and the axial length of the sleeve being less than 40 inches.

10. The filter housing of claim 1, wherein
the outer radial portion has a tubular shape that encircles the inner radial portion, and
the filter housing is configured to dispose the filter member in the interior volume of the sleeve between the outer radial portion and the inner radial portion of the interior volume.

11. A method of filtering liquid with a filter that includes a filter member and a filter housing, the filter housing including a sleeve, a first endcap coupled to a first open end of the sleeve and including a first plurality of ports, and a second endcap coupled to a second open end of the sleeve and including a second plurality of ports, at least one of the first endcap and the second endcap being removably coupled to the sleeve, the filter member disposed in the sleeve between the first endcap and the second endcap, the method comprising:
supplying a liquid into the filter housing through at least a first port in the first plurality of ports in the first endcap;
directing a first portion of the liquid from the first port in the first endcap to a first port in the second plurality of ports, which includes passing the first portion of the liquid through the filter member; and
discharging the first portion of the liquid from the filter through the first port in the second endcap, the first portion of the liquid being a permeate.

12. The method of claim 11, further comprising:
directing a second portion of the liquid from the first port in the first endcap to a second port in the first plurality of ports, which includes passing the second portion of the liquid through the filter member, the second portion of the liquid being a permeate.

13. The method of claim 11, further comprising:
directing a second portion of the liquid from the first port in the first endcap to a second port in the first endcap without passing through the filter member,
discharging the second portion of the liquid from the filter through the second port in the second endcap, the second portion of the liquid being a retentate.

14. The method of claim 11, wherein
the first endcap includes an end that is removably coupled to the first open end of the sleeve, each port in the first plurality of ports having a respective opening in the end of the first endcap,
the second endcap includes an end that is removably coupled to the second open end of the sleeve, each port in the second plurality of ports having a respective opening in the end of the second endcap, and
the directing of the first portion of the liquid includes directing the first portion of the liquid from the respective opening of the first port in the first plurality of ports to the respective opening of the first port in second plurality of ports.

15. The method of claim 11, wherein sleeve has an axial length that extends from the first end of the sleeve to the second end of the sleeve, and the axial length of the sleeve being less than 40 inches.

16. The method of claim 11, wherein
the filter member has a tubular shape,
an outer radial volume is formed between the sleeve and the filter member, the outer radial volume having a tubular shape that encircles the filter member.

17. A filter, comprising:
a filter member; and
a filter housing enclosing the filter member, the filter housing including:
a sleeve including a first open end, a second open end, and an interior volume, the filter member disposed in the interior volume of the sleeve, the interior volume having an outer radial portion and an inner radial portion;
a first endcap coupled to the first open end of the sleeve, the first endcap including a first plurality of ports that connect to the outer radial portion and the inner radial portion of the interior volume of the sleeve; and
a second endcap coupled to the second open end of the sleeve, the second endcap including a second plurality of ports that connect to the outer radial portion and the inner radial portion of the interior volume of the sleeve,
wherein at least one of the first endcap and the second endcap is removably coupled to the sleeve, and the filter member is enclosed in the sleeve between the first endcap and the second endcap.

18. The filter of claim 17, wherein the filter member is configured to filter liquid and to be replaceable from the housing.

19. The method of claim 17, wherein the sleeve has a tubular shape, and a longitudinal axis of the sleeve and a longitudinal axis of the filter member are coaxial.
